(19) United States
(12) Patent Application Publication
(10) Pub. No.: US 2007/0017817 A1
(43) Pub. Date: Jan. 25, 2007

(54) Method for manufacturing components of a gas turbine and a component of a gas turbine

(76) Inventors: Claus Mueller, Unterhaching (DE); Albin Platz, Ried-Baindlkirch (DE)

Correspondence Address: KENYON & KENYON LLP, ONE BROADWAY, NEW YORK, NY, 10004, US

(21) Appl. No.: 11/158,120

(22) Filed: Jun. 20, 2005

(30) Foreign Application Priority Data
Jun. 19, 2004 (DE) 10 2004 029 789.4

(51) Int. Cl. B23H 5/00

(52) U.S. Cl. 205/640

(57) ABSTRACT

A method for manufacturing components of a gas turbine includes at least the following steps: a) a component is produced using a metal injection molding process (MIM process); b) subsequently, the component produced using the metal injection molding process is machined to completion on its surface using a precise electrochemical machining process (PECM process).

### CROSS-REFERENCE TO RELATED APPLICATIONS

The present application claims priority to Application No. 10 2004 029 789.4, filed in the Federal Republic of Germany on Jun. 19, 2004, which is expressly incorporated herein in its entirety by reference thereto.

### FIELD OF THE INVENTION

The present invention relates to a method for manufacturing components of a gas turbine and to a component of a gas turbine.

### BACKGROUND INFORMATION

Modern gas turbines, particularly aircraft engines, must satisfy the highest demands with respect to reliability, weight, performance, economic efficiency and durability. In the last decades, aircraft engines were developed, particularly in the civil sector, which fully satisfy the above requirements and have achieved a high degree of technical perfection. Among other things, the selection of materials, the search for new suitable materials and the search for new manufacturing methods play a decisive role in the development of aircraft engines.

The most important materials used today for aircraft engines or other gas turbines are titanium alloys, nickel alloys (also called super alloys) and high-strength steels. The high-strength steels are used for shaft components, gear components, compressor housings and turbine housings. Titanium alloys are typical materials for compressor parts. Nickel alloys are suitable for the hot parts of the aircraft engine. First and foremost, investment casting and forging are conventional as manufacturing methods for gas turbine components made of titanium alloys, nickel alloys or other alloys. All highly stressed gas turbine components, as for example components for a compressor, are forged parts. Components for a turbine, by contrast, are normally manufactured as investment casting parts.

For manufacturing or producing complex components on the basis of metallic or even ceramic powders, powder-metallurgical injection molding represents an interesting alternative. Powder-metallurgical injection molding is related to plastic injection molding and is also known as the metal injection molding method (MIM method). Powder-metallurgical injection molding can be used to produce components that achieve almost the full density as well as nearly the static strength of forged parts. The dynamic strength, as a rule reduced in comparison to forged parts, can be compensated by a suitable choice of material.

Conventionally, powder-metallurgical injection molding roughly proceeds such that in a first method step a powder, preferably a metal powder, hard metal powder or even ceramic powder, is mixed with a binding agent and possibly with a plasticizer and other additives into a homogeneous mass. Molded bodies are manufactured from this homogeneous mass by injection molding. The injection-molded bodies already possess the geometric form of the component to be produced, their volume being increased, however, by the volume of the added binding agent and plasticizer. In a debinding process, the binding agent and plasticizer are withdrawn from the injection-molded bodies. Subsequently, during the sintering, the molded body is compacted or shrunk to yield the finished component. During the sintering, the volume of the molded body is reduced, it being decisive that the dimensions of the molded part must shrink in a controlled manner in all three spatial directions. Depending on the binding agent and plasticizer content, the linear shrinkage of the volume ranges between 10% and 20%.

The metal injection molding method can already be used to produce components of a sufficiently high quality for applications in the consumer goods industry and electronics as well as in automobile manufacturing and machine construction. For powder-metallurgical injection molding, however, the so-called net shape contour accuracy may be problematic. That is, for applications in gas turbine construction subject to the highest tolerance requirements for example, it is today only insufficiently possible to adhere to narrow tolerances for thin-walled components or components having a complex three-dimensional surface contour such that expensive refinishing work is required for such components. In particular, for example, the net shape production of certain turbine vane geometries of guide vanes or moving vanes of a gas turbine as well as the production of thin-walled honeycomb seals using MIM technology causes problems.

### SUMMARY

According to an example embodiment of the present invention, a method includes at least the following steps: a) a component is produced using a metal injection molding process (MIM process); b) subsequently, the component produced using the metal injection molding process is machined to completion on its surface using a precise electrochemical machining process (PECM process).

For manufacturing gas turbine components, the component is produced in a first step with the aid of an MIM process or powder-metallurgical injection molding, and, subsequently, the surface of the component thus produced is machined to completion using a PECM process. Thus, thin-walled gas turbine components having a complex three-dimensional surface contour may be produced in a particularly suitable manner using the combination of an MIM process and a subsequent PECM process. In the produced component, the MIM process provides a uniform structure having a specific particle size, which has a positive influence on the machining quality achievable using a PECM process, e.g., the achievable surface quality. Thus, gas turbine components may be manufactured using a combination of an MIM process and a PECM process. This combines the potentials of both processes.

According to an example embodiment of the present invention, a method for manufacturing components of a gas turbine includes: producing a component by a metal injection molding process; and machining to completion a surface of the component produced by the metal injection molding process by a precise electrochemical machining process.

The gas turbine may be arranged as a gas turbine of an aircraft engine.

A tolerance measurement of the component may be in a range of ±100 μm, e.g., ±50 μm, e.g., ±25 μm.

A particle size at the surface of the component produced by the metal injection molding process to be machined by the precise electrochemical machining process may be between 2 μm and 100 μm, e.g., between 5 μm and 50 μm.

A surface roughness of the component following the precise electrochemical machining process may be smaller than 1 μm.

In the metal injection molding process, a metal alloy powder may be used as a metal powder.

The metal alloy power may include a nickel base alloy powder, a steel alloy powder, a titanium base alloy powder, or at least one of (a) an intermetallic alloy powder and (b) a TiAl alloy powder.

The component may include a thin-walled component for a gas turbine at least one of (a) a complex three-dimensional and (b) a narrowly toleranced surface contour. The gas turbine may be one of (a) a gas turbine for an aircraft engine and (b) a stationary gas turbine.

The component may includes one of (a) a guide vane and (b) a moving vane for a gas turbine, which may be one of (a) a gas turbine for an aircraft engine and (b) a stationary gas turbine.

The component may include a sealing segment for a gas turbine, which may be one of (a) a gas turbine for an aircraft engine and (b) a stationary gas turbine.

According to an example embodiment of the present invention, a component of a gas turbine is formed by a method comprising: producing a component by a metal injection molding process; and machining to completion a surface of the component produced by the metal injection molding process by a precise electrochemical machining process.

Tolerance measurements of the component may be in a range of ±100 μm, e.g., ±50 μm, e.g., ±25 μm.

A surface roughness of the component following the precise electrochemical machining process may be smaller than 1 μm.

A material of the component may include a metal alloy.

A material of the component may include one of (a) a nickel base alloy, (b) a titanium base alloy, (c) a steel alloy and (d) an intermetallic alloy.

The component may include a thin-walled gas turbine component having at least one of (a) a complex three-dimensional and (b) a narrowly toleranced surface contour.

The component may include one of (a) a guide vane and (b) a moving vane for a gas turbine. The gas turbine may be one of (a) a gas turbine for an aircraft engine and (b) a stationary gas turbine.

The component may include a sealing segment for a gas turbine, which may be one of (a) a gas turbine for an aircraft engine and (b) a stationary gas turbine.

Further aspects and features hereof are described in the following description with reference to the appended Figure.

### BRIEF DESCRIPTION OF THE DRAWING

FIG. 1 is a block diagram illustrating individual method steps of a metal injection molding process according to an example embodiment of the present invention.

### DETAILED DESCRIPTION

The present invention relates to the manufacture of components of a gas turbine, e.g., an aircraft engine, a stationary gas turbine, etc.

It is provided to manufacture gas turbine components, e.g., thin-walled gas turbine components and/or gas turbine components having a complex, narrowly toleranced, three-dimensional surface contour by producing, in a first step, the component using powder-metallurgical injection molding or MIM process, and subsequently machining the surface of the component produced in the MIM process using a PECM process.

The components are produced with the aid of an MIM process having a low allowance of up to 0.5 mm. Such a low allowance subsequently may allow for the achievement of short PECM process times.

Although the details of metal injection molding (MIM) as well as of electrochemical machining (PECM) are believed to be familiar to a person skilled in the art, these two processes are discussed briefly below for the sake of completeness.

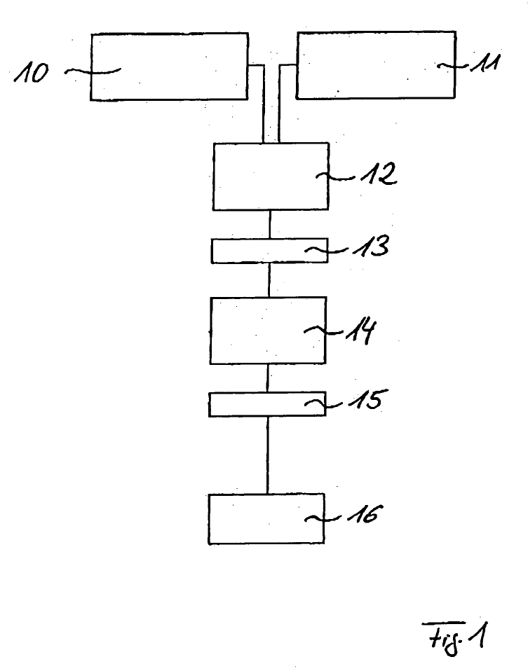

The individual method steps of the powder-metallurgical injection molding or MIM process are explained with reference to FIG. 1. In a first step 10, a metal powder, hard metal powder or ceramic powder is provided. In a second step 11, a binding agent and, if indicated, a plasticizer and, if indicated, additives are provided. The metal powder provided in method step 10 as well as the binding agent and plasticizer and, if indicated, the additives provided in method step 11 are mixed in method step 12 such that a homogenous mass is formed. For this purpose, the volumetric component of the metal powder in the homogeneous mass may amount to between 50% and 70%. The proportion of binding agent and plasticizer in the homogeneous mass consequently ranges between approximately 30% and 50%. This homogeneous mass made of metal powder, binding agent and plasticizer is processed further in step 13 by injection molding. Molded bodies are formed in injection molding. These molded bodies already have all of the typical features of the components to be produced. For example, the molded bodies have the geometric form of the component to be manufactured. However, they have a volume enlarged by the content of binding agent and plasticizer. In subsequent step 14, the binding agent and the plasticizer are expelled from the molded body. Method step 14 may also be called the debinding process. The expulsion of binding agent and plasticizer may occur in different manners. This may occur by fractioned thermal decomposition or vaporization. Another possibility is to draw off the thermally liquified binding and plasticizing agents using capillary forces, sublimation, solvents, etc. Following the debinding process in step 14, the molded bodies are sintered in step 15. During the sintering, the molded bodies are compacted or shrunk to yield the components having the final geometric properties. During the sintering, therefore, the molded bodies are reduced in size, the dimensions of the molded bodies having to shrink in all three spatial directions, ideally in a uniform or controlled manner. Depending on the binding agent and plasticizer content, the linear shrinkage amounts to between 10% and 20%. The sintering may be performed in various protective gases or in a vacuum. Following the sintering, the component is ready, which is illustrated in FIG. 1 by step 16. In the MIM process, a metal alloy powder is used as the metal powder for manufacturing gas turbine components, a nickel base alloy powder, a steel alloy powder, a titanium base alloy powder, etc. being used, depending on the component to be produced. Moreover, intermetallic alloy powders, e.g., TiAl alloy powder, ceramic powders, etc., may be used as well.

The precise electrochemical machining process (PECM process) is an electrochemical removal method, which may achieve a significantly better or higher precision than a classical ECM process. The PECM process is an electrochemical removal method using, e.g., a vibrating electrode, e.g., a pulsating direct voltage being applied between the electrode and a surface of the component to be machined. By this it is possible to achieve a removal of material on the surface of the component to be machined. In the PECM process, small gap dimensions between the electrode and the surface of component to be machined are maintained, it being possible to reduce the gap dimensions compared to the classical ECM process to, e.g., approx. 10 μm. Since in gaps this small it may no longer be possible to carry out the necessary rinsing of the gap using fresh electrolyte, the removal and the rinsing are performed in succession. The removal is performed when the gap is as narrow as possible, while the rinsing is performed when the gap is as large as possible. This ultimately results in a vibrating or oscillating electrode movement.

The method according may be used to manufacture components having a tolerance within a range of ±100 μm, e.g., within a range of ±50 μm, e.g., within a range of ±25 μm. The MIM process results in components having a particle size ranging from 2 μm to 100 μm, e.g., ranging from 5 μm to 50 μm. The surface roughness is formed accordingly. Following the PECM process, the surface roughness of the component may be less than 1 μm.

As already mentioned, the method may be particularly suitable for producing thin-walled gas turbine components and/or gas turbine components having a complex, three-dimensional as well as narrowly toleranced surface contour. For example, guide vanes or even moving vanes having thin-walled vane blades of complex shape as well as sealing segments for aircraft engines may be produced, for example.

What is claimed is:

1. A method for manufacturing components of a gas turbine, comprising:
producing a component by a metal injection molding process; and
machining to completion a surface of the component produced by the metal injection molding process by a precise electrochemical machining process.

2. The method according to claim 1, wherein the gas turbine is arranged as a gas turbine of an aircraft engine.

3. The method according to claim 1, wherein a tolerance measurement of the component is in a range of ±100 μm.

4. The method according to claim 1, wherein a tolerance measurement of the component is in a range of ±50 μm.

5. The method according to claim 1, wherein a tolerance measurement of the component is in a range of ±25 μm.

6. The method according to claim 1, wherein a particle size at the surface of the component produced by the metal injection molding process to be machined by the precise electrochemical machining process is between 2 μm and 100 μm.

7. The method according to claim 1, wherein the particle size at the surface of the component produced by the metal injection molding process to be machined by the precise electrochemical machining process is between 5 μm and 50 μm.

8. The method according to claim 1, wherein a surface roughness of the component following the precise electrochemical machining process is smaller than 1 μm.

9. The method according to claim 1, wherein in the metal injection molding process, a metal alloy powder is used as a metal powder.

10. The method according to claim 9, wherein the metal alloy power includes a nickel base alloy powder.

11. The method according to claim 9, wherein the metal alloy powder includes a steel alloy powder.

12. The method according to claim 9, wherein the metal alloy powder includes a titanium base alloy powder.

13. The method according to claim 9, wherein the metal alloy powder includes at least one of (a) an intermetallic alloy powder and (b) a TiAl alloy powder.

14. The method according to claim 1, wherein the component includes a thin-walled component for a gas turbine having at least one of (a) a complex three-dimensional and (b) a narrowly toleranced surface contour.

15. The method according to claim 14, wherein the gas turbine is one of (a) a gas turbine for an aircraft engine and (b) a stationary gas turbine.

16. The method according to claim 1, wherein the component includes one of (a) a guide vane and (b) a moving vane for a gas turbine.

17. The method according to claim 16, wherein the gas turbine is one of (a) a gas turbine for an aircraft engine and (b) a stationary gas turbine.

18. The method according to claim 1, wherein the component includes a sealing segment for a gas turbine.

19. The method according to claim 18, wherein the gas turbine is one of (a) a gas turbine for an aircraft engine and (b) a stationary gas turbine.

20. A component of a gas turbine formed by a method comprising:
producing a component by a metal injection molding process; and
machining to completion a surface of the component produced by the metal injection molding process by a precise electrochemical machining process.

21. The component according to claim 20, wherein tolerance measurements of the component are in a range of ±100 μm.

22. The component according to claim 20, wherein tolerance measurements of the component are in a range of ±50 μm.

23. The component according to claim 20, wherein tolerance measurements of the component are in a range of ±25 μm.

24. The component according to claim 20, wherein a surface roughness of the component following the precise electrochemical machining process is smaller than 1 μm.

25. The component according to claim 20, wherein a material of the component includes a metal alloy.

26. The component according to claim 20, wherein a material of the component includes one of (a) a nickel base alloy, (b) a titanium base alloy, (c) a steel alloy and (d) an intermetallic alloy.

27. The component according to claim 20, wherein the component includes a thin-walled gas turbine component having at least one of (a) a complex three-dimensional and (b) a narrowly toleranced surface contour.

28. The component according to claim 20, wherein the component includes one of (a) a guide vane and (b) a moving vane for a gas turbine.

29. The component according to claim 28, wherein the gas turbine is one of (a) a gas turbine for an aircraft engine and (b) a stationary gas turbine.

30. The component according to claim 20, wherein the component includes a sealing segment for a gas turbine.

31. The component according to claim 30, wherein the gas turbine is one of (a) a gas turbine for an aircraft engine and (b) a stationary gas turbine.
